(19) United States
(12) Patent Application Publication
(10) Pub. No.: US 2026/0339990 A1
(43) Pub. Date: Oct. 29, 2026

(54) Revision of and Attribution for Output of Text Generation Models

(71) Applicant: Google LLC, Mountain View, CA (US)

(72) Inventors: Kelvin Gu, Redwood City, CA (US); Zhuyun Dai, Sunnyvale, CA (US); Arun Tejasvi Chaganty, Mountain View, CA (US); Yuzhe Zhao, San Francisco, CA (US); Panupong Pasupat, Sunnyvale, CA (US); Yicheng Fan, Mountain View, CA (US); Da-Cheng Juan, Sunnyvale, CA (US); Ni Lao, Belmont, CA (US); Hong Rae Lee, Sunnyvale, CA (US); Luyu Gao, Pittsburgh, PA (US); Anthony Wah Chen, Sacramento, CA (US)

(21) Appl. No.: 19/116,911

(22) PCT Filed: Sep. 29, 2023
(86) PCT No.: PCT/US2023/034184

§ 371 Date: Mar. 28, 2025

Related U.S. Application Data
(60) Provisional application No. 63/411,428, filed on Sep. 29, 2022.

(51) Int. Cl. G06F 16/3329; G06F 16/953; G06F 40/169

(52) U.S. Cl. CPC G06F 16/33295; G06F 16/953; G06F 40/169

(57) ABSTRACT

Existing language models (LMs) can excel at some tasks such as question answering, reasoning, and dialog. However, they can sometimes generate unsupported or inaccurate content. Therefore, in the present disclosure, systems and methods are provided for improving the reliability of LMs' generated output. First, systems and methods are provided for editing LMs' generated content based on a machine-learned comparison between the generated content and related evidence snippets, which can be retrieved and extracted using a machine-learned query generation model and a machine-learned relevance model. Second, systems and methods are provided for attributing parts of LM-generated content (e.g. factual claims) to related evidence snippets. Thus, the present disclosure can improve the reliability of LM output, both by increasing the factual accuracy of edited content and by allowing a user or computing system to know whether parts of the generated content are supported or contradicted by external evidence.

### PRIORITY CLAIM

The present application is based on and claims priority to U.S. Provisional Application 63/411,428 having a filing date of Sep. 29, 2022, which is incorporated by reference herein.

### FIELD

The present disclosure relates generally to machine learning. More particularly, the present disclosure relates to machine-learned methods for providing revision and attribution (e.g. citation) for text (e.g. machine-generated text from an existing large language model).

### BACKGROUND

Text generation models (TOMs) are now the backbone of many Al systems. For example, large language models can enable multi-step reasoning, planning, rich interactions with the outside world, and open-domain question answering on par with traditional information retrieval systems.

Despite these advances, state-of-the-art TGMs can in some situations produce incorrect or unsupported content. Because of this issue, the output of a TGM may be unsuitable for certain tasks. Thus, it is desirable to generate methods for verifying the reliability of generated content.

### SUMMARY

Aspects and advantages of embodiments of the present disclosure will be set forth in part in the following description, or can be learned from the description, or can be learned through practice of the embodiments.

Example aspects of the present disclosure provide an example computer-implemented method for improved attribution of model-generated content. The method can comprise obtaining, by a computing system comprising one or more computing devices, a first textual content generated by a first machine-learned language model. The method can further comprise retrieving, by the computing system, one or more evidence sources relating to the first textual content generated by the first machine-learned language model. The method can further comprise generating, by the computing system, a second textual content as an output of a second machine-learned language model, based on a comparison between the first textual content and the one or more evidence sources. And the method can further comprise associating, by the computing system, one or more portions of the one or more evidence sources as attributions for the first or second textual content.

In some instances, retrieving, by the computing system, the one or more evidence sources can comprise generating, by the computing system, one or more queries based on the first textual content; and retrieving, by the computing system, the one or more evidence sources based on the one or more queries.

In some instances, retrieving, by the computing system, the one or more evidence sources based on the one or more queries can comprise a web search.

In some instances, generating, by the computing system, one or more queries based on the first textual content can comprise prompting a third machine-learned language model.

In some instances, generating, by the computing system, one or more queries based on the first textual content can comprise identifying one or more claims associated with the first textual content; and generating a query associated with at least one of the one or more claims.

In some instances, the example computer-implemented method can comprise prompting a third machine-learned language model to identify one or more claims associated with the first textual content.

In some instances, the example computer-implemented method can comprise prompting a third machine-learned language model to generate a query associated with at least one or more claims associated with the first textual content.

In some instances, prompting a third machine-learned language model can comprise few-shot prompting.

In some instances, prompting a third machine-learned language model can comprise chain-of-thought prompting.

In some instances, the example computer-implemented method can comprise extracting, by the computing system, one or more evidence snippets from the one or more evidence sources retrieved by the computing system; and comparing, by the computing system, the one or more evidence snippets extracted by the computing system to the first textual content.

In some instances, extracting, by the computing system, one or more evidence snippets from the one or more evidence sources retrieved by the computing system can comprise: determining one or more candidate evidence snippets; generating, for each candidate evidence snippet, a respective score based on a query that was used to retrieve the one or more evidence sources; and selecting a subset of candidate evidence snippets based on the respective scores.

In some instances, the respective scores can be relevance scores generated by a machine-learned query-document relevance model.

In some instances, the one or more evidence sources are textual documents, and determining one or more candidate evidence snippets can comprise running a sliding window across a respective textual document.

In some instances, selecting a subset of candidate evidence snippets based on the respective score can comprise maximizing a coverage over the one or more claims.

In some instances, comparing, by the computing system, the one or more evidence snippets extracted by the computing system to the first textual content can comprise determining one or more first levels of agreement, with respect to one or more claims associated with the first textual content, between the one or more evidence snippets and the first textual content.

In some instances, determining one or more first levels of agreement, with respect to one or more claims associated with the first textual content, between the one or more evidence snippets and the first textual content can comprise evaluating the first textual content and the evidence snippet with a machine-learned agreement model.

In some instances, evaluating the first textual content and the evidence snippet with a machine-learned agreement model can comprise prompting the machine-learned agreement model with chain-of-thought prompting.

In some instances, evaluating the first textual content and the evidence snippet with a machine-learned agreement model can comprise prompting the machine-learned agreement model with few-shot prompting.

In some instances, generating, by the computing system, a second textual content as an output of a second machine-learned language model can comprise identifying a respective claim of the one or more claims associated with the first textual content, wherein the first level of agreement with respect to the respective claim indicates a lack of complete agreement; and generating a second textual content, such that a second level of agreement, with respect to the respective claim and between the second textual content and the one or more evidence snippets, indicates a greater degree of agreement than the first level of agreement with respect to the respective claim.

In some instances, generating, by the computing system, a second textual content as an output of a second machine-learned language model can comprise prompting the second machine-learned language model using chain-of-thought prompting.

In some instances, generating, by the computing system, a second textual content as an output of a second machine-learned language model can comprise prompting the second machine-learned language model using few-shot prompting.

In some instances, the example computer-implemented method can further comprise determining an edit distance based on one or more differences between the first textual content and the second textual content; and based on the edit distance, determining whether to output the second textual content.

In some instances, the example computer-implemented method can further comprise determining an agreement score between the second textual content and one or more evidence snippets extracted from the one or more evidence sources; determining a preservation score indicative of a similarity between the first textual content and the second textual content; and based on a combination of the agreement score and the preservation score, determining whether to output the second textual content.

In some instances, the one or more evidence sources can be textual documents.

Other example aspects of the present disclosure provide an example computing system. The example computing system can comprise one or more processors and one or more non-transitory computer-readable media. The one or more non-transitory computer-readable media can store instructions that are executable by the one or more processors to cause the computing system to perform one or more operations. The operations can comprise obtaining a first textual content generated by a first machine-learned language model. The operations can further comprise retrieving one or more evidence sources relating to the first textual content generated by the first machine-learned language model. The operations can further comprise generating a second textual content as an output of a second machine-learned language model, based on a comparison between the first textual content and the one or more evidence sources. And the operations can further comprise associating one or more portions of the one or more evidence sources as attributions for the first or second textual content.

Other example aspects of the present disclosure provide one or more example computer-readable media. The example computer-readable media can store instructions that are executable by a computing system to cause the computing system to perform one or more operations. The operations can comprise obtaining a first textual content generated by a first machine-learned language model. The operations can further comprise retrieving one or more evidence sources relating to the first textual content generated by the first machine-learned language model. The operations can further comprise generating a second textual content as an output of a second machine-learned language model, based on a comparison between the first textual content and the one or more evidence sources. And the operations can further comprise associating one or more portions of the one or more evidence sources as attributions for the first or second textual content.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system 100 that performs attribution for automatically generated text according to example embodiments of the present disclosure.

FIG. 1B depicts a block diagram of an example computing device that performs attribution for automatically generated text according to example embodiments of the present disclosure.

FIG. 1C depicts a block diagram of an example computing device that performs attribution for automatically generated text according to example embodiments of the present disclosure.

FIG. 2 depicts a block diagram of an example system and workflow for editing and attributing machine-generated text according to example embodiments of the present disclosure.

FIG. 3 depicts a block diagram of an example method for editing and/or attributing machine-generated text according to example embodiments of the present disclosure.

FIG. 4 depicts a block diagram of an example method for retrieving evidence snippets related to machine-generated text according to example embodiments of the present disclosure.

FIG. 5 depicts a block diagram of an example method in which machine-generated text is compared to one or more retrieved evidence snippets according to example embodiments of the present disclosure.

FIG. 6 depicts a block diagram of an example method for editing machine-generated text according to example embodiments of the present disclosure.

FIG. 7 depicts a block diagram of an example experiment and corresponding example output, in which a machine-generated text is edited and attributed to evidence snippets according to example embodiments of the present disclosure.

FIG. 8 depicts a block diagram of an example experiment and corresponding example output, in which a machine-generated text is edited according to example embodiments of the present disclosure.

FIG. 9 depicts example few-shot prompts for prompting example machine-learned models in example experiments according to the present disclosure.

FIG. 10 is a flow chart diagram illustrating an example method for training a machine-learned model according to example implementations of aspects of the present disclosure.

FIG. 11 is a block diagram of an example processing flow for using machine-learned model(s) to process input(s) to generate output(s) according to example implementations of aspects of the present disclosure.

FIG. 12 is a block diagram of an example sequence processing model according to example implementations of aspects of the present disclosure.

FIG. 13 is a block diagram of an example technique for populating an example input sequence for processing by a sequence processing model according to example implementations of aspects of the present disclosure.

FIG. 14 is a block diagram of an example model development platform according to example implementations of aspects of the present disclosure.

FIG. 15 is a block diagram of an example training workflow for training a machine-learned model according to example implementations of aspects of the present disclosure.

FIG. 16 is a block diagram of an inference system for operating one or more machine-learned model(s) to perform inference according to example implementations of aspects of the present disclosure.

Reference numerals that are repeated across plural figures are intended to identify the same features in various implementations.

### DETAILED DESCRIPTION

### Overview

Existing language models (LMs) can excel at some tasks such as question answering, reasoning, and dialog. However, they sometimes generate unsupported or misleading content. Therefore, in one example aspect of the present disclosure, a mechanism is provided for attributing LMs' content to external evidence. In another example aspect of the present disclosure, a mechanism is provided for editing LMs' content to make it more consistent with external evidence.

In some example aspects of the present disclosure, systems and methods are provided that, given an input text generated by an LM, can retrieve external evidence relevant to the text, and then can revise the text to make it consistent with the evidence while preserving qualities like style or structure, enabling the revised text to be seamlessly used in place of the original.

In some example aspects of the present disclosure, an existing language model can generate factually unreliable textual content, and systems and methods of the present disclosure can edit the content to detect and correct errors in the generated textual content. A research stage can use a machine-learned query generator to raise questions about different aspects of the text, such as factual claims made by the text. Next, these queries can be used to retrieve evidence from a corpus of evidence sources, e.g. by using the queries to perform a web search for relevant textual documents. Next, a machine-learned relevance model can be used to extract a set of evidence snippets from the retrieved evidence sources, based on a machine-learned determination of which portions of the retrieved sources are most relevant to the generated queries. Next, a machine-learned agreement model can compare the evidence snippets to the generated textual content, and can detect any agreements or disagreements. Thus, it can be determined whether a factual claim in the generated textual content is supported by the extracted snippets; contradicted by the extracted snippets; or not addressed by the extracted snippets. Next, a machine-learned editing model can correct any textual content that is contradicted by the extracted snippets, while otherwise preserving the content and structure of the generated textual content.

Separately or additionally, systems and methods of the present disclosure can associate extracted evidence snippets with related parts of the generated textual content. Systems and methods of the present disclosure can then output information about the associated evidence snippets to a user or to another computing system or process. In some instances, the input textual content may be output unedited, in combination with a separate attribution report explaining which factual claims are supported by evidence; contradicted by evidence; or unaddressed by the evidence retrieved. In other example instances, the generated content may be edited for factual accuracy and the edited content may be accompanied by a separate attribution report. In other instances, the attributions can be included as part of the edited content, e.g. as an in-text citation. Although the preceding sentences discuss factual claims as an example, systems and methods of the present disclosure can also be used in relation to opinions and other aspects of the generated content (e.g. an attribution report identifying sources that disagree with an expressed opinion, or identifying general background information about a topic discussed).

In some additional aspects of the present disclosure, systems and methods are provided for measuring the quality of edited textual content and retrieved evidence snippets. Automated systems and methods are provided for measuring whether edited textual content is attributable to retrieved evidence sources. In some example experiments, it is shown that the provided methods are highly correlated with human judgments about attribution. Automated systems and methods are also provided for measuring how much of the original textual content is preserved within the edited textual content. In some example experiments using these measures, it is shown that the systems and methods of the present disclosure enable the editing of textual content to better agree with evidence, while preserving the original content better than prior methods.

The present disclosure provides several technical advantages and benefits which will be apparent to a person of skill in the art. For example, systems and methods provided in the present disclosure significantly improve attribution while otherwise preserving the original input to a much greater degree than prior work.

Furthermore, systems and methods of the present disclosure can be performed using only a small number of training examples, which can save computation costs associated with training a machine-learned model. Thus, systems and methods of the present disclosure can perform computational tasks using less electricity and computational time than prior systems and methods.

Furthermore, systems and methods of the present disclosure can be performed on text generated by already-existing language models, which can leverage the benefits of an expensive-to-train large language model (e.g. a trillion-parameter pretrained model) without the electricity and computational costs associated with retraining such a large model. Thus, systems and methods of the present disclosure can perform tasks that may be impossible without the aid of a large (e.g. trillion-parameter) model, and which cannot be performed by an existing large language model alone, using less electricity and other training costs than prior work.

Furthermore, systems and methods of the present disclosure can provide revised text that can be consistent with external evidence while preserving qualities like style or structure, enabling the revised text to be seamlessly used in place of the original. This prevents any need to generate additional text after editing is performed, thereby saving electricity and computational costs associated with generating additional text after editing.

Additionally, systems and methods of the present disclosure can generalize across many tasks better than prior work. Thus, systems and methods of the present disclosure enable the reuse of systems and methods across multiple tasks, which can save electricity, computational time, and memory space associated with training, storing, and operating separate machine-learned models for each task.

Furthermore, systems and methods of the present disclosure can be performed using already-existing document retrieval tools, such as a standard web search engine. Thus, systems and methods of the present disclosure can leverage the benefits of a powerful web search tool without using the electricity, computational time, and memory space that may be associated with training, storing, and operating a task-specific evidence retrieval tool.

Furthermore, systems and methods of the present disclosure can enable the use of smaller language models to achieve levels of performance similar to larger models, thereby saving the electricity, computational costs, and memory space associated with larger models. For example, larger language models (e.g. trillion-parameter models) have been shown to “hallucinate” less often than smaller (e.g. few-billion-parameter models) models, but training a larger model requires more electricity, more memory, and more processing time than a smaller model. Systems and methods of the present disclosure can enable the increased accuracy associated with larger models, without requiring the increased electricity, memory and processing time associated with training larger models.

With reference now to the Figures, example embodiments of the present disclosure will be discussed in further detail.

### Example Devices and Systems

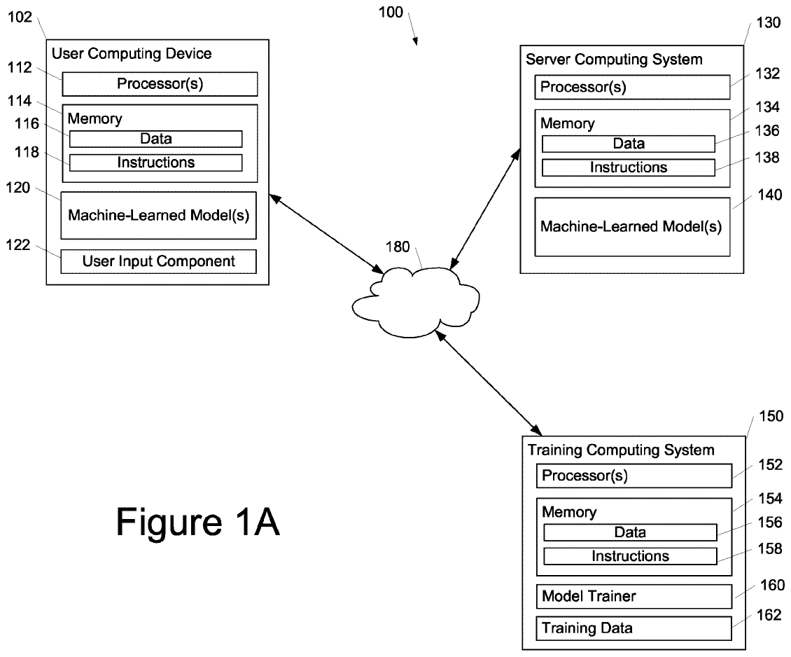

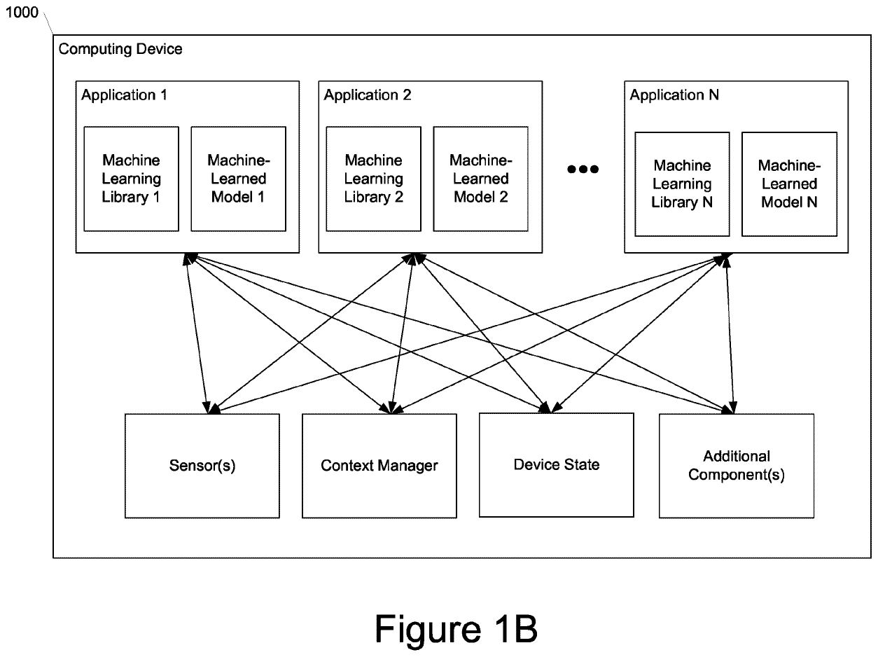

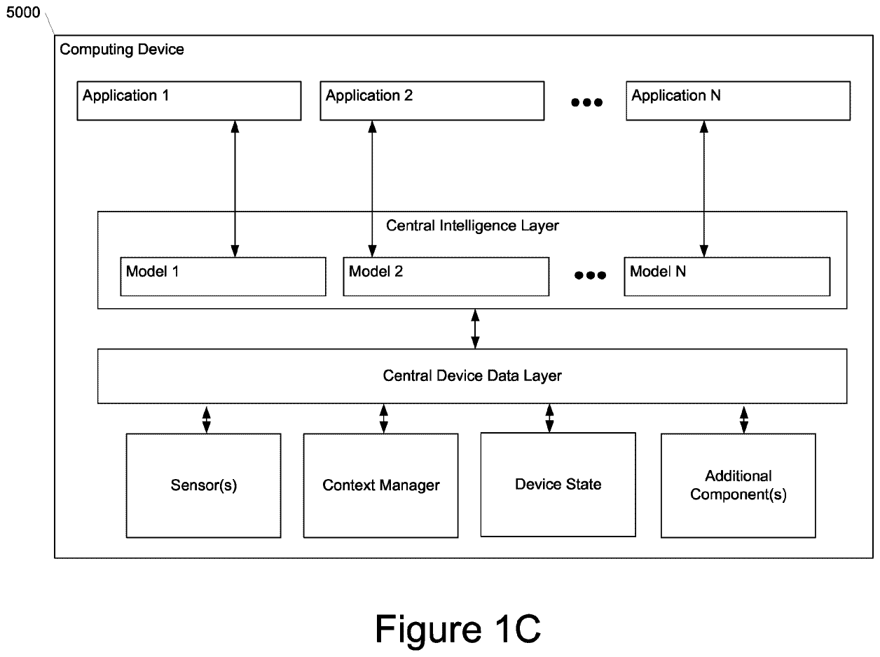

FIG. 1A depicts a block diagram of an example computing system 100 that performs attribution for automatically generated text according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more n models 120. For example, the text attribution models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more text attribution models 120 can be received from the server computing system 130 over network 180, stored in the user computing device memory 114, and then used or otherwise implemented by the one or more processors 112. In some implementations, the user computing device 102 can implement multiple parallel instances of a single text attribution model 120 (e.g., to perform parallel attribution for automatically generated text across multiple instances of attribution for automatically generated text).

Additionally or alternatively, one or more text attribution models 140 can be included in or otherwise stored and implemented by the server computing system 130 that communicates with the user computing device 102 according to a client-server relationship. For example, the text attribution models 140 can be implemented by the server computing system 140 as a portion of a web service (e.g., an attribution for automatically generated text service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more text attribution models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the text attribution models 120 and/or 140 based on a set of training data 162.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 1000 that performs according to example embodiments of the present disclosure. The computing device 1000 can be a user computing device or a server computing device.

The computing device 1000 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 5000 that performs according to example embodiments of the present disclosure. The computing device 5000 can be a user computing device or a server computing device.

The computing device 5000 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-leamed model. For example, in some implementations, the central intelligence layer can provide a single model for all of the applications. In some implementations, the central intelligence layer is included within or otherwise implemented by an operating system of the computing device 5000.

The central intelligence layer can communicate with a central device data layer. The central device data layer can be a centralized repository of data for the computing device 5000. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

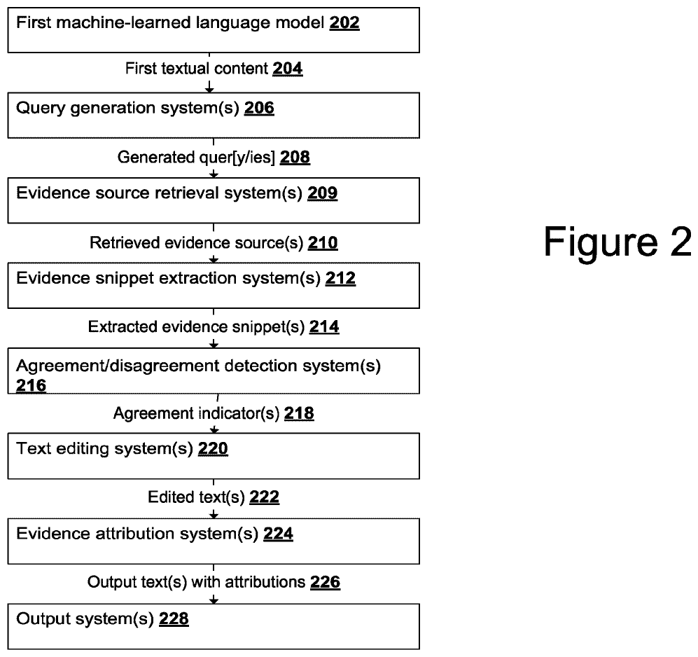

FIG. 2 depicts a block diagram of an example data workflow for editing and attributing machine-generated text according to example embodiments of the present disclosure. In FIG. 2, a first machine-learned language model 202 can output a first textual content 204, and a query generation system 206 can generate one or more queries 208 related to aspects of the first textual content 204. An evidence source retrieval system 209 can retrieve evidence sources 210 based on the queries 208. An evidence snippet extraction system 212 can then extract evidence snippets 214 from the evidence sources 210. An agreement/disagreement detection system 216 can then compare the extracted evidence snippets 214 with the first textual content 204 to determine one or more agreement indicator(s) 218 indicative of an agreement or disagreement between the first textual content 204 and one or more of the evidence snippets 214. A text editing system 220 can then create an edited text 222 based on the first textual content 204, evidence snippets 214, and agreement indicator(s) 218. An evidence attribution system 224 can attribute one or more aspects of the edited text 222 to one or more evidence snippets 214. The evidence attribution system 224 can then send an output 226 to an output system 228. The output 226 can comprise one or more texts (e.g. first textual content 204, edited text 222) combined with one or more attributions associating evidence snippets with the text(s).

FIG. 2 depicts a first machine-learned language model 202 outputting a first textual content 204. The first machine-learned language model can be, for example, any machine-learned language model capable of generating text. In some instances, the first machine-learned language model 202 can be a multi-headed self-attention model (e.g., transformer). The first textual content 204 can be, for example, natural language content. Although FIG. 2 depicts a first machine-learned model 202 outputting the first textual content 204, a person skilled in the art will appreciate that textual content can be generated or obtained in other ways, e.g. written by humans or retrieved from a database of textual content.

FIG. 2 depicts a query generation system 206 generating queries 208 based on the first textual content 204. In some cases, the query generation system can comprise a machine-learned model. In some instances, query generation system can comprise a machine-learned model using an attention mechanism, such as a multi-headed self-attention model (e.g. transformer). In some instances, few-shot prompting can be used to enable a pretrained general-purpose language model to perform query generation. In some instances, a pretrained model can be prompted with a small number (e.g. six) of example input/output pairs having an example text input and an example set of associated queries, where each example set of associated queries includes a question about every factual claim made in each example text input. In some instances, an example input can also comprise an example context (e.g. “context: Who was Abraham Lincoln? you said: He was the 16th president of the United States.”). Once prompted in this way, a pretrained language model can be given a first textual content 204 without a corresponding set of queries, and the pretrained model can then generate a set of queries 208 as output. In some instances, a query generation system can be used multiple times (e.g. three times) to generate multiple query sets based on one first textual content 204, and the queries 208 can be a union of the multiple query sets. However, a person skilled in the art will recognize that in some instances, queries can be generated without the use of a machine-learned model (e.g. using the entire first textual content 204 as a query, or parsing the first textual content 204 into sentences and using each sentence as a query).

FIG. 2 depicts an evidence source retrieval system 209 that can retrieve evidence sources 210 based on the generated queries 208. In some instances, the evidence source retrieval system 209 can be a standard web search engine. For example, each query in the generated queries 208 can be input into a standard web search engine, and a number (e.g. five) of top-ranked results associated with each query can be added to the retrieved evidence sources 210. In other instances, the evidence source retrieval system 209 may retrieve evidence sources from a non-internet-based corpus of evidence sources (e.g. a proprietary database containing proprietary data).

FIG. 2 depicts an evidence snippet extraction system 212 extracting evidence snippets 214 from the evidence sources 210. In some instances, the evidence snippet extraction system 212 can extract candidate evidence snippets from each web page by running a sliding window of four sentences across the evidence source 210, breaking at document headings. In some instances, the candidate evidence snippets can then be ranked based on their relevance to a respective query 208. In some instances, this ranking can be performed using a machine-learned model. In some instances, the ranking can be performed using a query-document relevance model, which can compute a relevance score between each query and each candidate evidence snippet. In some cases, the query-document relevance model can comprise a text-to-text transformer adapted to transfer learning. In some instances, the query-document relevance model can comprise a pretrained model that has been fine-tuned on a dataset having relevance labels. A number (e.g. 5) of top-ranked candidate evidence snippets can then be selected for each query 208, and the evidence snippets 214 can comprise the union of all top-ranked candidate evidence snippets for all generated queries 208.

FIG. 2 depicts agreement/disagreement detection system 216 comparing the extracted evidence snippets 214 with the first textual content 204 to determine one or more agreement indicator(s) 218 indicative of an agreement or disagreement between the first textual content 204 and one or more of the evidence snippets 214. In some cases, the agreement/disagreement detection system 216 can comprise a machine-learned model. In some instances, the agreement/disagreement detection system 216 can comprise a machine-learned model using an attention mechanism, such as a multi-headed self-attention model (e.g. transformer). In some instances, few-shot prompting can be used to enable a pretrained general-purpose language model to perform agreement/disagreement detection. In some instances, the few-shot prompting can also be chain-of-thought prompting, in which a pretrained model is prompted to explicitly state an implied answer to a query for each of an input textual content and an input evidence snippet. In some instances, a pretrained model can be prompted with a small number (e.g. eight) of agreement detection examples comprising a textual input, a query, an evidence snippet, and an example output explaining whether the provided evidence snippet and the textual input agree or disagree on the answer to the query. In some instances, an agreement detection example can also comprise an example input context (e.g. “context: Who was Abraham Lincoln?; you said: He was the 16th president of the United States.”).

FIG. 2 also depicts a text editing system 220 that can then create an edited text 222 based on the first textual content 204, evidence snippets 214, and agreement indicator(s) 218. In some instances, the text editing system 220 may be bypassed and the first textual content 204 may be output unedited, e.g. if no disagreement is detected by the agreement/disagreement detection system 216. In some cases, the text editing system 220 can comprise a machine-learned model. In some instances, the text editing system 220 can comprise a machine-learned model using an attention mechanism, such as a multi-headed self-attention model (e.g. transformer). In some instances, few-shot prompting can be used to enable a pretrained general-purpose language model to perform editing. In some instances, the few-shot prompting can also be chain-of-thought prompting, in which a pretrained model is prompted to explicitly identify a span of text in the first textual content 204 that needs to be edited before generating the edited text 222. In some instances, such chain-of-thought prompting can have the benefit of causing the text editing system 220 to preserve a greater percentage of the first textual content 204 while still correcting identified errors in the first textual content 204. In some instances, a pretrained model can be prompted with a small number (e.g. seven) of examples having an input text, a query, an evidence snippet, a statement identifying a specific span of text associated with a disagreement between the evidence snippet and the input text with respect to the query, and an example edited input text. In some instances, an example input can also comprise an example context (e.g. “context: Who was Abraham Lincoln?; you said: He was the 16th president of the United States.”).

FIG. 2 also depicts an evidence attribution system 224 attributing one or more aspects of the edited text 222 to one or more evidence snippets 214. In some instances, the evidence attribution system 224 can comprise a machine-learned model. In some instances, a machine-learned model used by the evidence attribution system 224 can also be used by the evidence snippet extraction system 214. In some instances, the evidence attribution system 224 can comprise a query-document relevance model, which can compute a relevance score between each query and each evidence snippet. In some cases, the query-document relevance model can comprise a text-to-text transformer adapted to transfer learning. In some instances, the query-document relevance model can comprise a pretrained model that has been fine-tuned on a dataset having relevance labels. A number (e.g. 5) of evidence snippets 214 can then be selected to create an attribution report attributing claims in the edited text 222 to one or more evidence snippets. In some instances, the evidence snippets can be selected to maximize an overall coverage score over all generated queries 208. In some instances, a query-specific coverage score for a respective query 208 can be a maximum relevance score computed between that query and all evidence snippets included in the attribution report. In some instances, an overall coverage score can be the sum over all generated queries 208 of each respective query-specific coverage score. However, a person of skill in the art will recognize that an attribution report can be compiled from evidence snippets 214 in other ways. In some instances, an attribution report can be output separately from the edited text 222. In other instances, an attribution report can be integrated into an edited text 222 as in-text citations.

FIG. 2 also depicts the evidence attribution system 224 sending an output 226 to an output system 228. The output 226 can comprise, for example, one or more texts (e.g. first textual content 204, edited text 222) combined with one or more attributions associating evidence snippets with the text(s). The output system can be, for example, a display shown to a user, an output connection to another computing system, or an output connection to another computer program being run on the same computing system as the evidence attribution system 224.

### Example Methods

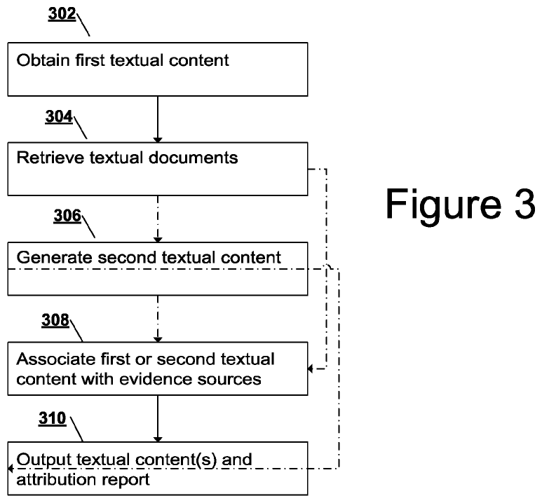

FIG. 3 depicts a block diagram of an example method for editing and/or attributing machine-generated text according to example embodiments of the present disclosure. In step 302, a first textual content 204 can be obtained. In step 304, one or more textual documents comprising one or more evidence sources 210 can be retrieved based on the first textual content 204. Optionally, in step 306, a second textual content (e.g. an edited text 222) can be generated based on the first textual content 204 and the one or more textual documents. Additionally or alternatively, in step 308, the first textual content 204 or the second textual content can be associated with the one or more evidence sources. In step 310, the first textual content 204 or second textual content can be output, along with an attribution report associating the one or more evidence sources with one or more aspects of the first or second textual content.

Step 302 depicts the first textual content 204 being obtained. A person skilled in the art will recognize that the first textual content 204 can be obtained in any appropriate way (e.g. using a machine-learned model to generate the first textual content; retrieving the content from a database; receiving the content as input from another computing system; etc.).

Step 304 depicts retrieving textual documents comprising one or more evidence sources 210 based on the first textual content 204. In some instances, this step can comprise using a query generation system 206 to generate queries 208, and then performing a standard web search using these queries. However, a person skilled in the art will recognize that other methods of retrieving relevant textual documents are possible.

Step 306 depicts generating a second textual content based on the first textual content 204 and the one or more textual documents retrieved in step 304. In some instances, this step can comprise using a text editing system 220 to generate an edited text 222. In some instances, this step can comprise using an agreement/disagreement detection system 216 to determine one or more agreement indicator(s) 218, and choosing not to edit if the agreement indicator(s) 218 do not show disagreement. In other instances, one or more agreement indicator(s) 218 can be obtained another way, such as by receiving an agreement indicator 218 from another computing system or from a user.

Step 308 depicts the first textual content 204 or the second textual content being associated with the one or more evidence sources. In some cases, step 308 can comprise using an evidence attribution system 224 to create an attribution report associating a first textual content 204 or an edited text 222 with one or more evidence snippets 214.

In step 310, the first textual content 204 or second textual content can be output, along with an attribution report associating the one or more evidence sources with one or more aspects of the first or second textual content. In some instances, step 310 can comprise using an output system 228 to output one or more output text(s) with attributions 226.

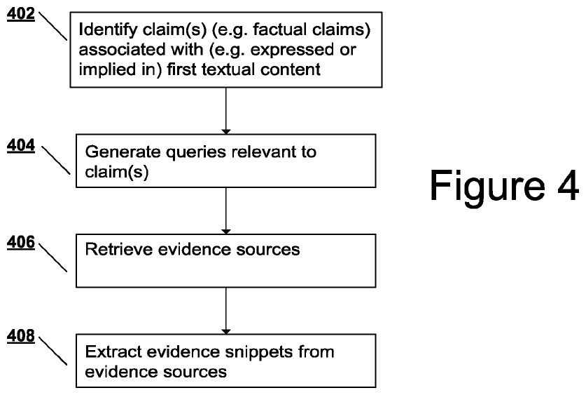

FIG. 4 depicts a block diagram of an example method for retrieving evidence snippets related to machine-generated text according to example embodiments of the present disclosure. In step 402, a machine-learned model can identify one or more claims (e.g. factual claims, opinion claims) associated with a first textual content 204. In some instances, step 402 can comprise using a query generation system 206. In some instances, step 402 can comprise few-shot or chain-of-thought prompting of a query generation system 206. In step 404, a machine-learned model can be used to generate queries 208 relevant to the identified claims. In some instances, step 404 can comprise using a query generation system 206. In some instances, step 404 can comprise few-shot or chain-of-thought prompting of a query generation system 206. In some instances, steps 402 and 404 can be performed simultaneously (e.g. using a single chain-of-thought prompt of a query generation system 206). In other instances, step 402 can be bypassed or performed implicitly as part of step 404. In step 406, the generated queries 208 can be used to retrieve evidence sources 210. In some instances, step 408 can comprise using an evidence source retrieval system 209. And in step 408, a machine-learned model can be used to extract evidence snippets 214 from the evidence sources 210. In some instances, step 408 can comprise using an evidence snippet extraction system 212.

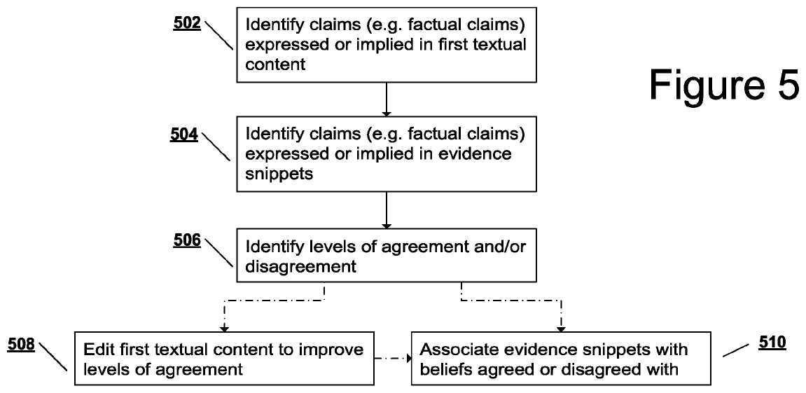

FIG. 5 depicts a block diagram of an example method in which a first textual content 204 is compared to one or more retrieved evidence snippets 214 according to example embodiments of the present disclosure.

In step 502, a machine-learned language model can identify claims (e.g. factual claims, opinion claims) expressed or implied in a first textual content 204. In some instances, step 502 can comprise using an agreement/disagreement detection system 216. In some instances, step 502 can comprise few-shot or chain-of-thought prompting of an agreement/disagreement detection system 216.

In step 504, a machine-learned model can identify claims expressed or implied in one or more evidence snippets 214. In some instances, step 504 can comprise using an agreement/disagreement detection system 216. In some instances, step 504 can comprise few-shot or chain-of-thought prompting of an agreement/disagreement detection system 216.

In step 506, a machine-learned model can identify a level of agreement or disagreement between the claims associated with the first textual content 204 and the claims associated with the evidence snippets 214. In some instances, steps 506 can comprise using an agreement/disagreement detection system 216 to determine one or more agreement indicator(s) 218. In some instances, step 506 can comprise few-shot or chain-of-thought prompting of an agreement/disagreement detection system 216. In some instances, two or more of steps 502, 504, and 506 can be performed simultaneously (e.g. using a single chain-of-thought prompt of an agreement/disagreement detection system 216). In other instances, one or more of steps 502 and 504 can be bypassed or performed implicitly as part of step 506.

In step 508, the first textual content 204 can be optionally edited to improve agreement between the first textual content 204 and the evidence snippets 214. In some instances, step 508 can comprise using a text editing system 220 to generate an edited text 222. In some instances, this step can comprise obtaining one or more agreement indicator(s) 218, and choosing not to edit if the agreement indicator(s) 218 do not show disagreement. In other instances, one or more agreement indicator(s) 218 can be obtained another way, such as by receiving an agreement indicator 218 from another computing system or from a user.

In step 510, one or more evidence snippets 214 can be associated with claims expressed or implied in the first textual content 204 or edited text 222, based on a level of agreement or disagreement. In some cases, step 510 can comprise using an evidence attribution system 224 to create an attribution report associating a first textual content 204 or an edited text 222 with one or more evidence snippets 214.

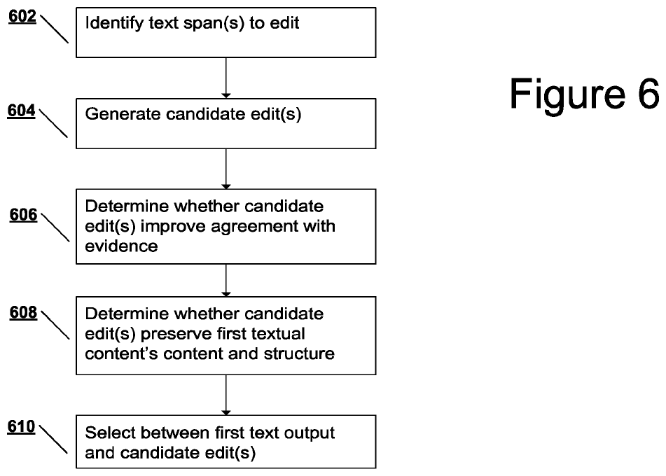

FIG. 6 depicts a block diagram of an example method for editing machine-generated text according to example embodiments of the present disclosure. In step 602, a computing system can identify text span(s) to edit. In some instances, step 602 can comprise using a text editing system 220. In some instances, step 602 can comprise few-shot or chain-of-thought prompting of a text editing system 220. In step 604, a computing system can generate one or more candidate edit(s). In some instances, step 604 can comprise using a text editing system 220. In some instances, step 604 can comprise few-shot or chain-of-thought prompting of a text editing system 220. In some instances, step 602 and step 604 can be performed simultaneously (e.g. using a single chain-of-thought prompt of text editing system 220). In other instances, step 602 can be bypassed or performed implicitly as part of step 604.

In step 606, a computing system can determine whether the candidate edit(s) improve a level of agreement between a body of evidence (e.g. one or more evidence snippets 214) and the edited textual content. In some instances, step 606 can comprise using an agreement/disagreement detection system 216 on an edited text 222. In some instances, step 606 can comprise computing an attribution metric indicative of a degree to which a sentence in an edited text 222 is attributable to one or more evidence snippets 214. In some instances, the attribution metric can comprise one or more attribution metrics disclosed in the Example Experiments section below.

In step 608, a computing system can determine whether the candidate edit(s) preserve the first textual content's 204 content and structure. In some instances, step 608 can comprise computing a preservation score indicative of a degree to which relevant aspects of the first textual content 204 are preserved by an edited text 222. In some instances, the preservation score can comprise one or more preservation metrics disclosed in the Example Experiments section below.

And in step 610, a computing system can select between the first textual content 204 and the candidate edit(s). In some instances, step 610 can comprise selecting based on one or more of a preservation score and an agreement score determined in steps 608 and 606 respectively. In some instances, step 610 can comprise selecting based on a combination of a preservation and an agreement score. In some instances, the combination can be based on a harmonic mean of a preservation score and an agreement score.

### Example Experiments

In this section, example metrics are disclosed for measuring the degree to which a text is attributable to one or more evidence sources, and for measuring the degree to which an edited text preserves the content of an original text. Experiments according to the present disclosure are also disclosed. In experiments, systems and methods of the present disclosure improved attribution of input text while preserving the content and structure of the input text better than prior work.

Regarding attribution, one available measure of attribution is known as Attributable to Identified Sources (AIS), a human evaluation framework which considers a binary notion of attribution. Under AIS, a text passage y is attributable to a set A of evidence if a generic hearer would affirm the statement “According to A, y” under the context of y. A system either receives full credit (1.0) if all content in y can be attributed to A, and no credit (0.0) otherwise.

In some instances, a more fine-grained, sentence-level extension of AIS can also be used. For example, annotators can be asked to give an AIS score for each sentence s of y, and then report the average AIS score across all sentences. Since the AIS score is binary, this effectively measures the percentage of sentences in y that are fully attributed to A.

When judging each sentence, annotators can also be given access to one or more surrounding sentences and any other necessary context, such as a question that the text passage responded to.

An automated metric that approximates buman AIS judgments can also be used. For example, a machine-learned natural language inference (NLI) model can be used to estimate a model probability of an evidence snippet 214 entailing a respective sentence contained in a first textual content 204 or edited text 222. In some instances, an NLI model can be based on a text-to-text transformer model adapted to transfer learning. In some instances, the NLI model can be a pretrained model that has been fine-tuned on evidence-claim-entailment triplets, where an entailment score can be “1” if the evidence entails the claim, and “0” if it does not. In some instances, an entailment score associated with an evidence snippet 214 and a sentence of an edited text 222 can be a model probability of outputting a “1” given the evidence snippet 214 and the sentence. For each sentence in a textual input, multiple estimated entailment probabilities can be computed, e.g. once for each evidence snippet in a plurality of evidence snippets. For each sentence, a maximum entailment probability across all evidence snippets can be that sentence's approximate AIS score. Once a set of sentence-by-sentence AIS scores have been approximated, an approximate AIS score for an entire text can be computed by averaging the sentence-by-sentence scores. In some example experiments according to the present disclosure, automated attribution metrics of the present disclosure had a strong Pearson correlation with metrics based on human evaluation.

In some instances, accuracy can be improved by decontextualizing each sentence based on the entire context of the textual input.

Regarding preservation, an intent preservation metric can be generated by asking human annotators to decide if the revision preserves a text's original intent (e.g. completely, somewhat, or not at all). Like AIS evaluation, annotators can be given any necessary surrounding context. A binary metric defining preservation of intent can be be 1.0 if the revision completely preserves the original intent, and 0.0 otherwise.

Additionally, a structure preservation metric can be defined to measure whether an editing system has made superfluous modifications, such as reordering words, changing textual style, or including unnecessary additional information. Different tasks may have different requirements for what should be preserved. In some instances, a metric that penalizes unnecessary changes can be readily computed. For example, a structure preservation metric can be based on a character-level Levenshtein edit distance between an input text and an output text (i.e. a minimum number of characters that must be changed or added to convert an input text into an output text). For example, a structure preservation metric can be equal to the greater of zero (0.0) and one minus a quotient computed by dividing a Levenshtein edit distance by an input length characterized by a number of characters in the input text (1—(lev(input output)/length(input). Such a metric can be 1.0 if the input and output are the same, and 0.0 if the output completely overwrites all of the input. A structural preservation metric can be computed in this way without the use of any human annotators, making it useful for fully automated computation of preservation metrics. A person skilled in the art will recognize that other metrics can be computed, and specialized preservation metrics may be useful for specialized tasks (e.g. preserving rhyme schemes or puns). In some example experiments according to the present disclosure, machine-computed structure preservation metrics of the present disclosure had a strong Pearson correlation with preservation metrics based on human evaluation.

A combined preservation metric can be computed by combining an intent preservation metric and a structure preservation metric. For example, a combined preservation metric can be equal to a product computed by multiplying an intent preservation metric by a structure preservation metric. Alternatively, a structure preservation metric or intent preservation metric can be used alone or combined with other metrics.

Additionally, a preservation metric can be combined with an attribution metric to create a combined preservation-attribution metric. For example, a harmonic mean of preservation and attribution can be computed. In some instances, this can be computed in the same way that an Fl score is computed using a harmonic mean of precision and recall. A combined preservation-attribution metric can be useful for measuring tasks where it is desirable to maximize both attribution and preservation, while navigating any tradeoffs between the two.

The example preservation and attribution metrics of the present disclosure have the advantage of not requiring any “gold” or “reference” edits (unlike many prior evaluations of text revision models), which are often only available for specialized domains. This enables broadening the scope to a much wider range of generation tasks.

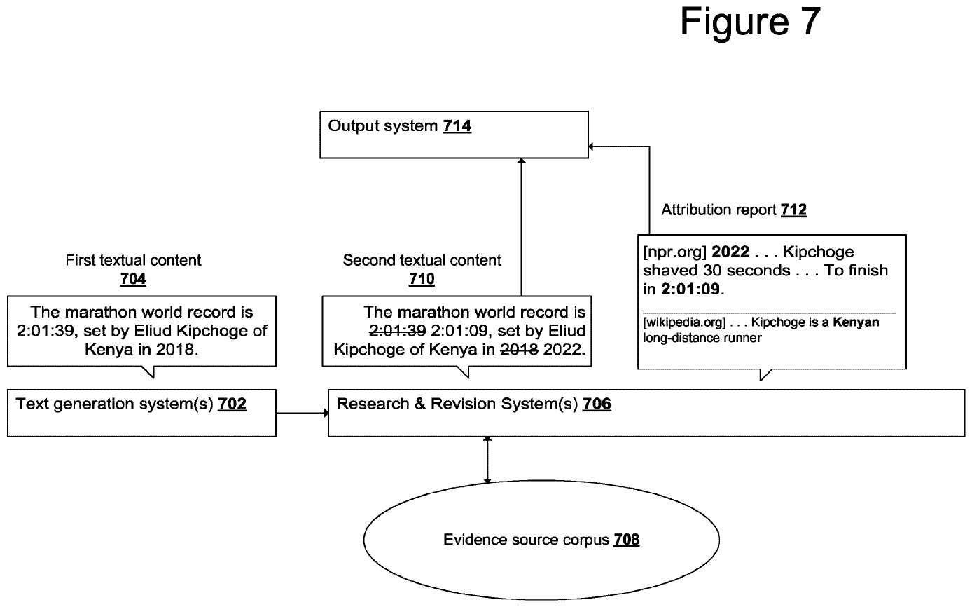

FIG. 7 depicts a block diagram of an example experiment and corresponding example output, in which a machine-generated text is edited and attributed to evidence snippets according to example embodiments of the present disclosure. According to FIG. 7, a text generation system 702 can generate a first textual content 704. In some example experiments according to the present disclosure, the text generation system can be a 540-billion-parameter decoder-only transformer-based language model. In some instances, the first textual content 704 can be generated by prompting the text generation system 702 with inputs designed to cause language models to produce factoid statements, reasoning chains, or knowledge-intensive dialogs. The depicted first textual content 704 comprises a factoid statement. A research and revision system 706 can then retrieve evidence sources 210 from an evidence source corpas 708 and can generate a second textual content 710 and an attribution report 712. In some example experiments according to the present disclosure, the research and revision system 706 can comprise a query generation system 206, an evidence source retrieval system 209, an evidence snippet extraction system 212, an agreement/disagreement detection system 216, a text editing system 220, and an evidence attribution system 224. In some instances, the evidence source corpus 708 can comprise internet-based evidence sources. The second textual content 710 and the attribution report 712 can then be provided to an output system 714. The depicted attribution report 712 comprises two evidence snippets 214.

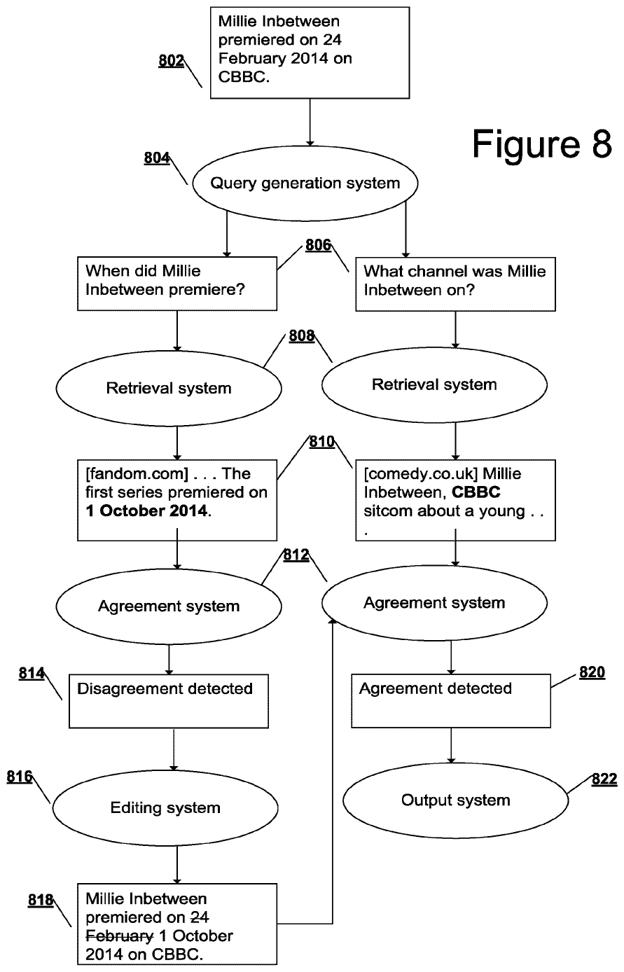

FIG. 8 depicts a block diagram of an example experiment and corresponding example output, in which a machine-generated text is edited according to example embodiments of the present disclosure. According to FIG. 8, a machine-generated text 802 can be input to a query generation system 804, which can then generate a plurality of queries 806 based on the machine-generated text 802. In some example experiments according to the present disclosure, the machine-generated text 802 can be generated by prompting a large (e.g., 540-billion-parameter) decoder-only transformer-based language model with inputs designed to cause language models to produce factoid statements, reasoning chains, or knowledge-intensive dialogs. In some instances, the resulting passages will be mostly coherent but often contained factual errors. When prompted with inputs designed to produce knowledge-intensive dialogs, the machine-generated text 802 may be a context-dependent output, characterized by pronouns and implicit references. In some instances, the query generation system 804 can comprise a query generation system 206.

A retrieval system 808 can use the queries 806 to retrieve one or more evidence snippets 810. An agreement system 812 can then compare the first evidence snippet 810 with the machine-generated text 802. The agreement system 812 can output an agreement indicator 814 showing disagreement. When a disagreement 814 is detected, an editing system 816 can edit the machine-generated text 802 to create an edited text 818. The agreement system 812 can then compare the second evidence snippet 810 with the edited text 818, outputting an agreement indicator 820 showing agreement. When an agreement 820 is detected, the edited text 818 can be sent, without any additional editing, either to an output system 822 or to the agreement system for comparison with additional evidence snippets 810. In some instances, the retrieval system 808, agreement system 812, and editing system 816 can comprise an evidence source retrieval system 209, agreement/disagreement detection system 216, and text editing system 220 respectively.

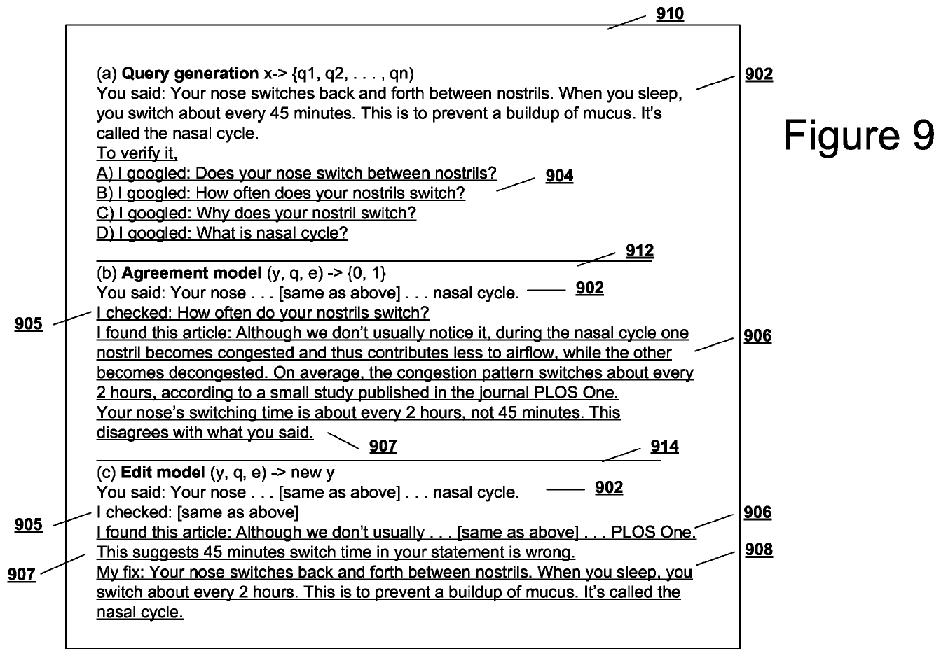

In some example experiments according to the present disclosure, few-shot prompting of a general-purpose large language model was used for the query generation step, the agreement/disagreement detection step, and the edit step. FIG. 9 depicts examples of few-shot prompts used to prompt an example query generation model 206, an example agreement/disagreement detection system 216, and an example text editing system 220 in example experiments according to the present disclosure. Block (a) depicts a query generation prompt 910 comprising an example input 902 and a corresponding example query set 904. Block (b) depicts a disagreement detection prompt 912 comprising an example input 902, an example query 905, an example evidence snippet 906, and an example disagreement indicator 907. Block (c) depicts an example edit model prompt 914 comprising an example input 902, an example evidence query 905, an example evidence snippet 906, an example disagreement indicator 907, and an example edited textual content 908.

In some example experiments according to the present disclosure, six query generation prompts 910 can be input into a large (e.g., 540-billion-parameter) decoder-only transformer-based large language model. In other example experiments, other model sizes can be used (e.g. 62 billion parameters). This small number of human-drafted examples can be sufficient for a pretrained machine-learned model to adequately learn the task. To increase diversity and coverage, a machine-learned model can be used three times to generate three sets of queries, and the generated queries 208 can comprise the union of the resulting queries. For each of the generated queries 208, a web search can be used to retrieve S web pages per query. In some example experiments, queries can be generated without the use of any machine-learned query generation model (e.g. by using the entire first textual content 204 as one query, or by using each sentence in the first textual content 204 as a query). In some instances, experiments using a machine-learned query generation model will achieve higher combined attribution-preservation scores than experiments using queries generated without a machine-learned model. Additionally, in some instances, queries generated by a machine-learned model can cause an evidence source retrieval system 209 to retrieve more up-to-date evidence sources, or to retrieve relevant sources that are more likely to contradict errors in the first textual input 204.

In some example experiments according to the present disclosure, a query-document relevance model can be trained to compute a relevance score between a query 208 and an evidence snippet 214. Candidate evidence snippets can then be extracted from each web page by running a sliding window of four sentences across an evidence source 210, breaking at document headings. One or more candidate evidence snippets can then be ranked for each query based on one or more relevance scores between the query and each candidate evidence snippet. In some example experiments, the highest-scoring evidence snippet for each query can be retained. In other instances, a different number of evidence snippets can be retained.

In some example experiments according to the present disclosure, a small number of disagreement detection prompts 912 can be input into a large (e.g., 540-billion-parameter) decoder-only transformer-based large language model. In other example experiments, other model sizes can be used (e.g. 62 billion parameters). In some instances, eight disagreement detection prompts 912 comprising an example input 902, an example query 905, an example evidence snippet 906, and an example disagreement indicator 907 can be used. This small number of human-drafted examples can be sufficient for a pretrained machine-learned model to adequately learn the task. After a model learns the task, the model can then be prompted with one or more input combinations comprising a textual input (e.g. a first textual content 204), a generated query 208, and an extracted evidence snippet 214, which can cause the model to output one or more agreement indicator(s) 218.

In some example experiments according to the present disclosure, a text editing system 220 can process every first textual content 204, without using any agreement/disagreement detetion system(s) 216 to detect disagreements first. In some instances, experiments using a machine-learned agreement detection model can achieve higher combined attribution-preservation scores than experiments that do not use an agreement detection model.

In some example experiments according to the present disclosure, a small number of edit model prompts 914 can be input into a 540-billion-parameter decoder-only transformer-based large language model. In other example experiments, other model sizes can be used (e.g. 62 billion parameters). In some instances, a machine-learned model can be prompted with seven edit model prompts 914 comprising an example input 902, an example evidence query 905, an example evidence snippet 906, an example disagreement indicator 907, and an example edited textual content 908. This small number of human-drafted examples can be sufficient for a pretrained machine-learned model to adequately learn the task. After a model learns the task, the model can then be prompted with one or more input combinations comprising a textual input (e.g. a first textual content 204), a generated query 208, an extracted evidence snippet 214, and an agreement indicator 218, which can cause the model to output one or more edited texts 222.

In some example experiments according to the present disclosure, up to five evidence snippets 214 can be selected to form an attribution report. In some instances, a query-document relevance model can be used to compute a relevance score between each query 208 and each evidence snippet 214. A set of evidence snippets can then be selected to maximize a coverage over all queries, computed as a sum over all queries of a query-specific coverage score for each query 208, wherein the query-specific coverage score is a maximum of a plurality of relevance scores computed between the query 208 and each evidence snippet 214 included in the attribution report.

In some example experiments according to the present disclosure, outputs from the example systems were scored for preservation and attribution and compared to outputs from other systems. In some instances, example embodiments of the present disclosure improved an attribution score of the edited text 222 relative to the first textual content 204. while also maintaining a high preservation score for the edited text 222 relative to the first textual content 204. The example systems and methods of the present disclosure achieved attribution scores similar to other work while achieving much higher preservation scores, thereby achieving much higher combined attribution-preservation scores. In some example settings, the systems and methods of the present disclosure preserved the original intent of input text over 90% of the time, while other tested systems preserved the original intent between 6% and 40% of the time. In some example settings, editing systems according to the present disclosure increased attribution by up to 13% absolute compared to unedited textual content, while changing only 10-20% of the text.

### Example Model Training

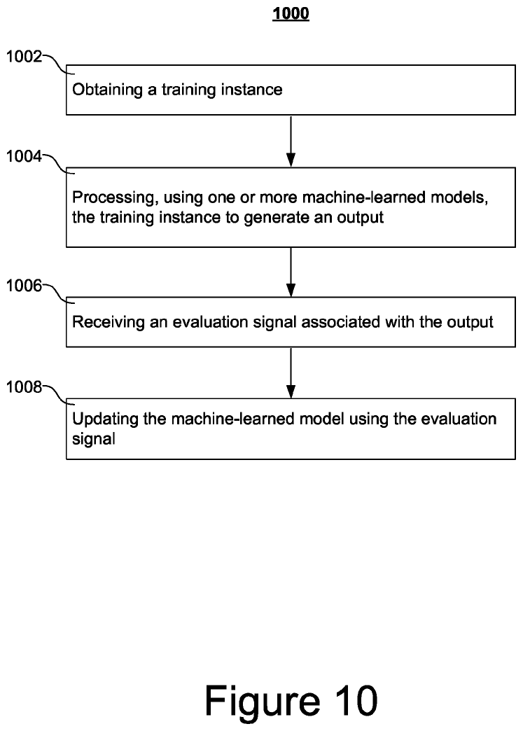

FIG. 10 depicts a flowchart of a method 1000 for training one or more machine-learned models according to aspects of the present disclosure. For instance, an example machine-learned model can include a text generation model such as a large language model.

One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

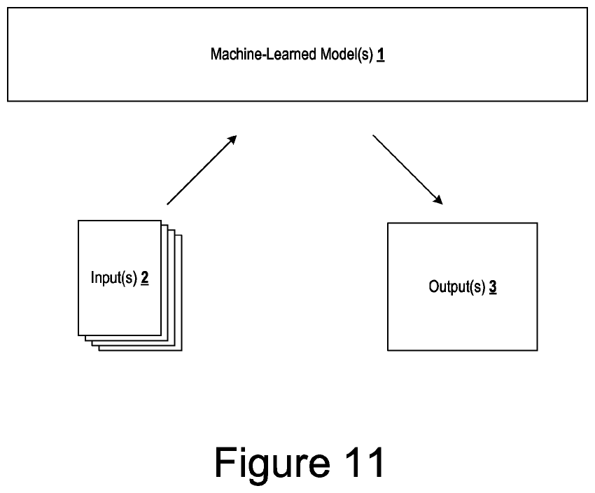

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV:2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

### Example Machine-Learned Sequence Processing Models

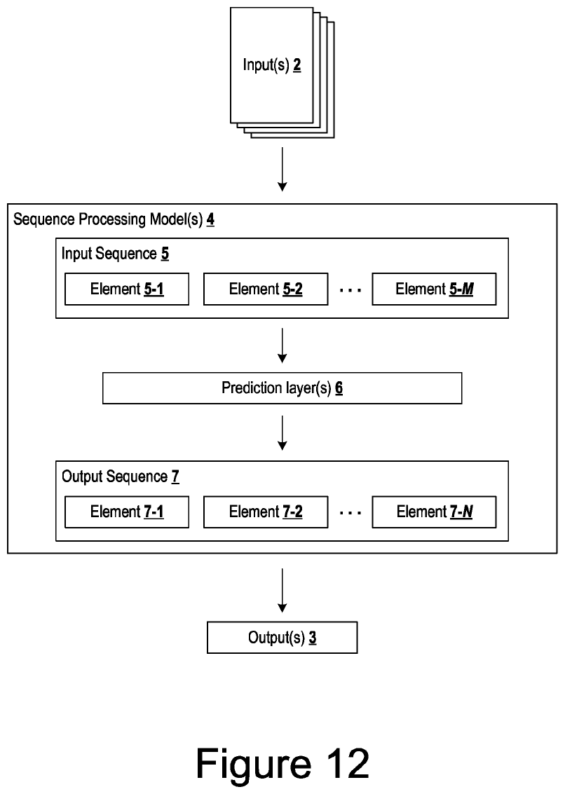

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2,. 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https:/ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence S. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer, For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively, For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

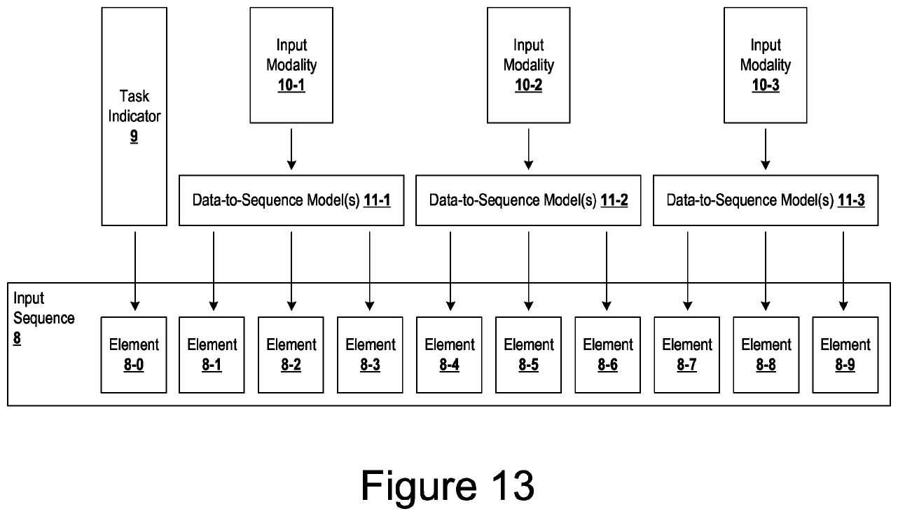

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence & (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information, An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

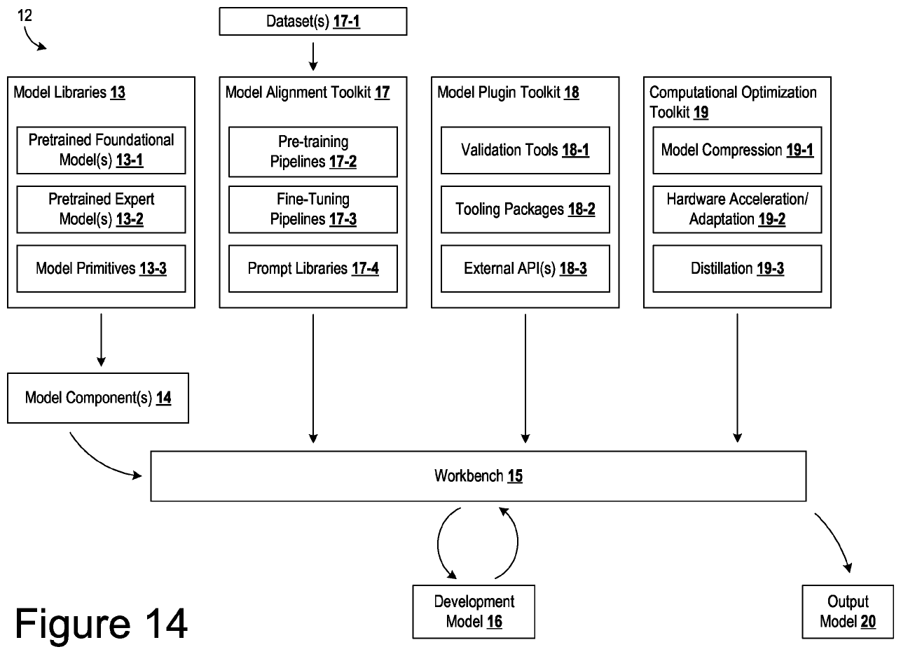

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tmed models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or leaming optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-leamed models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 1000 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models-e.g., understanding an intent in an unstructured request for a task-while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

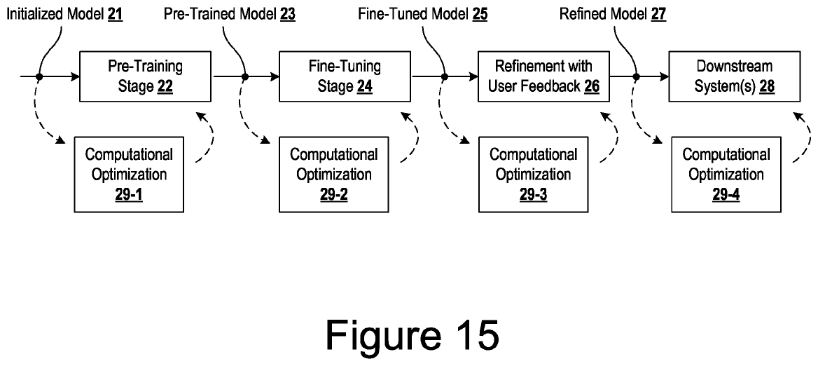

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

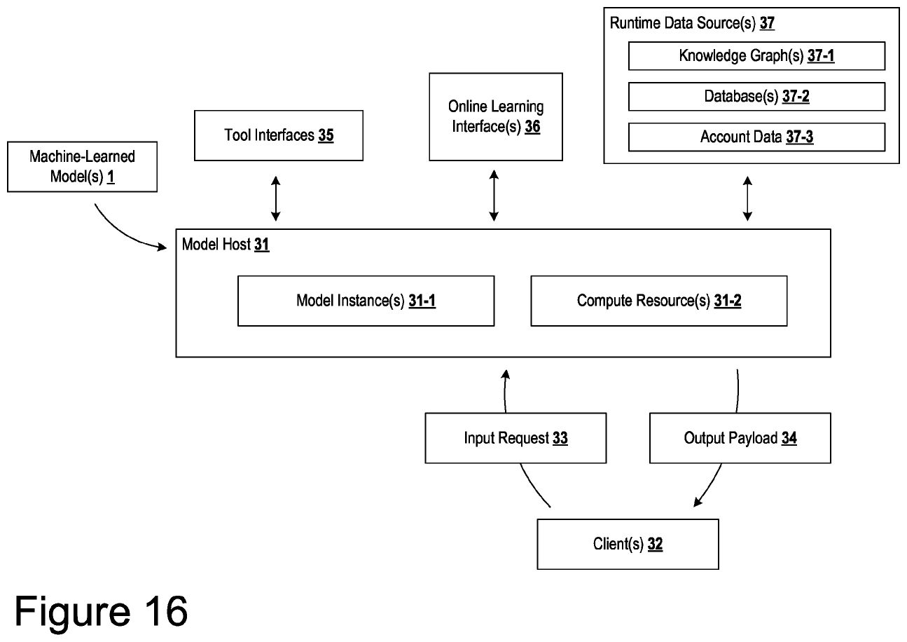

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLIIF). Online learning interface(s) 36 can facilitate federated learning of machine-learned model(s) 1.

Model host 31 can execute machine-learned model(s) I to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) I can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.).

Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-leamed model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for improved attribution of model-generated content, the method comprising:
obtaining, by a computing system comprising one or more computing devices, a first textual content generated by a first machine-learned language model;
retrieving, by the computing system, one or more evidence sources relating to the first textual content generated by the first machine-learned language model;
generating, by the computing system, a second textual content as an output of a second machine-learned language model, based on a comparison between the first textual content and the one or more evidence sources; and
associating, by the computing system, one or more portions of the one or more evidence sources as attributions for the first or second textual content.

2. The method of claim 1, wherein retrieving, by the computing system, the one or more evidence sources comprises:
generating, by the computing system, one or more queries based on the first textual content; and
retrieving, by the computing system, the one or more evidence sources based on the one or more queries.

3. The method of claim 2, wherein retrieving, by the computing system, the one or more evidence sources based on the one or more queries comprises a web search.

4. The method of claim 1, wherein generating, by the computing system, one or more queries based on the first textual content comprises prompting a third machine-learned language model.

5. The method of claim 1, wherein generating, by the computing system, one or more queries based on the first textual content comprises:
identifying one or more claims associated with the first textual content; and
generating a query associated with at least one of the one or more claims.

6. The method of claim 1, comprising:
performing at least one of:
prompting a third machine-learned language model to identify one or more claims associated with the first textual content; or
prompting a third machine-learned language model to generate a query associated with at least one of the one or more claims.

7. The method of claim 6, wherein prompting a third machine-learned language model comprises few-shot prompting.

8. The method of claim 6, wherein prompting a third machine-learned language model comprises chain-of-thought prompting.

9. The method of claim 1, further comprising:
extracting, by the computing system, one or more evidence snippets from the one or more evidence sources retrieved by the computing system; and
comparing, by the computing system, the one or more evidence snippets extracted by the computing system to the first textual content.

10. The method of claim 9, wherein extracting, by the computing system, one or more evidence snippets from the one or more evidence sources retrieved by the computing system comprises:
determining one or more candidate evidence snippets;
generating, for each candidate evidence snippet, a respective score based on a query that was used to retrieve the one or more evidence sources; and
selecting a subset of candidate evidence snippets based on the respective scores.

11. The method of claim 10, wherein the respective scores are relevance scores generated by a machine-learned query-document relevance model.

12. The method of claim 10 or 11, wherein:
the one or more evidence sources are textual documents; and
determining one or more candidate evidence snippets comprises running a sliding window across a respective textual document.

13. The method of claim 10, wherein selecting a subset of candidate evidence snippets based on the respective score comprises:
maximizing a coverage over the one or more claims.

14. The method of claim 9, wherein comparing, by the computing system, the one or more evidence snippets extracted by the computing system to the first textual content comprises:
determining one or more first levels of agreement, with respect to one or more claims associated with the first textual content, between the one or more evidence snippets and the first textual content.

15. The method of claim 14, wherein determining one or more first levels of agreement, with respect to one or more claims associated with the first textual content, between the one or more evidence snippets and the first textual content comprises:
evaluating the first textual content and the evidence snippet with a machine-learned agreement model.

16. The method of claim 15, wherein evaluating the first textual content and the evidence snippet with a machine-learned agreement model comprises prompting the machine-learned agreement model with chain-of-thought prompting.

17. The method of claim 15, wherein evaluating the first textual content and the evidence snippet with a machine-learned agreement model comprises prompting the machine-learned agreement model with few-shot prompting.

18. The method of claim 14, wherein generating, by the computing system, a second textual content as an output of a second machine-learned language model comprises:
identifying a respective claim of the one or more claims associated with the first textual content, wherein the first level of agreement with respect to the respective claim indicates a lack of complete agreement; and
generating a second textual content, such that a second level of agreement, with respect to the respective claim and between the second textual content and the one or more evidence snippets, indicates a greater degree of agreement than the first level of agreement with respect to the respective claim.

19. The method of claim 1, wherein generating, by the computing system, a second textual content as an output of a second machine-learned language model comprises prompting the second machine-learned language model using chain-of-thought prompting.

20. The method of claim 1, wherein generating, by the computing system, a second textual content as an output of a second machine-learned language model comprises prompting the second machine-learned language model using few-shot prompting.

21. The method of claim 1, further comprising:
determining an edit distance based on one or more differences between the first textual content and the second textual content; and
based on the edit distance, determining whether to output the second textual content.

22. The method of claim 1, further comprising:
determining an agreement score between the second textual content and one or more evidence snippets extracted from the one or more evidence sources;
determining a preservation score indicative of a similarity between the first textual content and the second textual content; and
based on a combination of the agreement score and the preservation score, determining whether to output the second textual content.

23. The method of claim lany claim, wherein:
the one or more evidence sources are textual documents.

24. A computing system, comprising:
one or more processors; and
one or more non-transitory computer-readable media storing instructions that are executable by the one or more processors to cause the computing system to perform one or more operations, the operations comprising:
obtaining a first textual content generated by a first machine-learned language model;
retrieving one or more evidence sources relating to the first textual content generated by the first machine-learned language model;
generating a second textual content as an output of a second machine-learned language model, based on a comparison between the first textual content and the one or more evidence sources; and
associating one or more portions of the one or more evidence sources as attributions for the first or second textual content.

25. One or more computer-readable media storing instructions that are executable by a computing system to cause the computing system to perform one or more operations, the operations comprising:
obtaining a first textual content generated by a first machine-learned language model;
retrieving one or more evidence sources relating to the first textual content generated by the first machine-learned language model;
generating a second textual content as an output of a second machine-learned language model, based on a comparison between the first textual content and the one or more evidence sources; and
associating one or more portions of the one or more evidence sources as attributions for the first or second textual content.
